(19) United States
(12) Patent Application Publication
(10) Pub. No.: US 2016/0288086 A1
(43) Pub. Date: Oct. 6, 2016

(54) LOW SOLUBLE ARSENIC DIATOMITE FILTER AIDS

(71) Applicant: EP MINERALS, LLC, Reno, NV (US)

(72) Inventors: Qun Wang, Reno, NV (US); David Scott Keselica, Lakeland, FL (US); Kimberly Walsh, Sandy, UT (US); Peter E. Lenz, Reno, NV (US); Chongjun Jiang, Reno, NV (US); Bradley Scott Humphreys, Sparks, NV (US)

(21) Appl. No.: 15/035,160

(22) PCT Filed: Oct. 16, 2014
(86) PCT No.: PCT/US14/60856

§ 371 Date: May 6, 2016

Related U.S. Application Data
(63) Continuation-in-part of application No. PCT/US2013/069441, filed on Nov. 11, 2013.

(51) Int. Cl. B01J 20/14; B01J 20/04; C12H 1/07; B01J 20/30; C12H 1/044; B01J 20/08; B01J 20/283

(52) U.S. Cl. CPC B01J 20/14; B01J 20/08; B01J 20/043; B01J 20/283; B01J 20/3078; C12H 1/0408; C12H 1/063; B01J 2220/42

(57) ABSTRACT

Low soluble arsenic diatomite filter aids and method of making such filter aids are disclosed. Alumina and/or aluminum hydroxide (ATH) are used as additives when preparing the filter aids, which may be straight-calcined or flux-calcined. Alternatively, activated alumina may be added to an already straight-calcined or flux-calcined diatomite filter aid. As compared to either straight-calcined or soda ash flux-calcined diatomite filter aids of similar permeabilities made from the same ore, the disclosed filter aids have lower soluble arsenic content. The disclosed filter aids have a soluble arsenic content, either by the OIV, EBC or USFCC method, of about 60% or less than the straight or flux-calcined diatomite filter aids of similar permeability without an alumina or ATH additive.

TECHNICAL FIELD

This disclosure relates to diatomite or diatomaceous earth filter aids with reduced soluble arsenic content and methods for reducing the soluble arsenic content in diatomite or diatomaceous earth filter aids.

### BACKGROUND

Diatomite (diatomaceous earth) is sediment that includes silica in the form of siliceous skeletons (frustules) of diatoms. Diatoms are a diverse array of microscopic, single-celled, golden-brown algae generally of the class Bacillariophyceae that possess ornate siliceous skeletons of varied and intricate structures. Because of these ornate skeletal structures, diatomite is useful as a filter aid for separating particles from fluids. The intricate and porous structures unique to diatomite can physically entrap particles during filtration processes. Diatomite can also improve the clarity of fluids that exhibit turbidity or contain suspended particles or particulate matter.

Because diatoms are water-borne, diatomite deposits occur at locations relating to either existing or former bodies of water. Further, diatomite deposits may be divided into freshwater and saltwater categories.

When used as a filter aid, the arsenic in a diatomite product may become soluble in the liquid being filtered. In many applications, this increase in arsenic content in the fluid being filtered may be undesirable or even unacceptable. The potential undesired health impact from arsenic dissolved from diatomite filter aids is discussed by Webber and Taylor, J. Institute of Brewing, Vol. 59 (1953), p. 392-397. For example, when diatomite filter aids are used to filter beer, arsenic dissolved in the beer may exceed the accepted level of arsenic in drinking water, or greater than 10 ppb. In fact, some beers filtered with diatomite have arsenic levels of greater than 25 ppb. Thus, brewing and other food and beverage industries demand diatomite filter aids with a low content of arsenic that is soluble in the liquids or beverages to be filtered.

Food safety authorities in many jurisdictions require the soluble arsenic content of a diatomite filter aid to be below certain level, as defined by a respective extraction method. For example, many national food safety standards dictate strong acid extraction methods when defining the soluble arsenic content. The US Food Chemical Codex (USFCC) and the US Pharmacopeia (USP) define the soluble arsenic content as arsenic that is extractible by contacting 10 g of a diatomite sample in 50 ml of 0.5 N hydrochloric acid (HCl) at 70° C. for 15 minutes and further limit the soluble arsenic to less than 10 ppm. In contrast, mild acidic extraction methods are dictated by beverage industrial associations. The European Brewing Convention (EBC) requires diatomite filter aids to have soluble arsenic content of less than 10 ppm when a 5 g of a diatomite sample is contacted with 200 ml of a 1% potassium hydrogen phthalate (KHP) solution at pH 4 at ambient temperature for 2 hours. The International Oenological Codex, established by Organisation Internationale de la Vigne et du Vin (OIV), sets the soluble arsenic limit at 3 ppm, when a 10 g diatomite sample is contacted for 1 hour at 20° C. with 200 ml of 5 g/liter citric acid acidified to a pH of 3.

One method of reducing arsenic in a diatomite filter aid is the ore selection; some diatomite ores naturally contain less arsenic than other ores. While some ores contain a relatively high arsenic content, due to the overall ore chemistry, diatomite filter aids made from these ores may still have a relatively low soluble arsenic content. Ore selection alone, however, may not be sufficient to supply the brewing and other industries with diatomite filter aids having the requisite low soluble arsenic content.

Another method known to reduce soluble arsenic content in diatomite filter aids is the process of calcination. Calcination generally involves heating diatomite at a high temperature, for example, in excess of 900° C. (1652° F.). Two types of calcination processes are commonly practiced in the diatomite industry: straight-calcination and flux-calcination. Straight calcination does not involve the addition of a fluxing agent, and straight calcination usually reduces the presence of organics and volatiles in diatomite. Straight calcination may also induce a color change from off-white to tan or pink. Straight calcination produces filter aids of low to medium permeability, usually up to 0.7 Darcy. Flux-calcination involves the use of one or more fluxing agents, commonly a sodium salt such as sodium carbonate (soda ash) or chloride (common salt), to produce more permeable filter aids of up to 10 Darcy. Calcination temperature and/or degree of calcination will also affect the soluble arsenic content. It is known that low permeability, straight calcined diatomite filter aids may present challenges in controlling soluble arsenic content.

Yet another method of reducing soluble arsenic content in diatomite filter aids is to remove arsenic bearing impurities in diatomite. This may include beneficiation of raw diatomite ores to remove arsenic bearing mineral impurities and/or acid wash of a diatomite filter aid to dissolve arsenic prior to its end use. U.S. Pat. No. 6,653,255 teaches a method of producing purified diatomite filter aids having reduced soluble impurities, including arsenic, wherein the method includes both beneficiation and acid washing. However, diatomite filter aids produced by this and similar methods are expensive due to the high energy costs of dewatering and drying after wet processes are carried out.

Adsorptive media, such as activated alumina, iron hydroxide/oxide, zeolite, and zirconium hydroxide, may be used to remove arsenic from drinking water (Rubel, Design Manual: Removal of Arsenic from Drinking Water by Absorptive Media, US EPA/600/R-03/019, 2003). U.S. Patent Application 2009/0101588 discloses an adsorptive medium consisting of metal hydroxide gel precipitated on diatomite for arsenic and other metal removal from water. Similarly, U.S. Patent Application 2010/0307968 discloses a water filter of activated carbon containing an arsenic adsorbent such as activated alumina to reduce arsenic leached from the activated carbon.

Certain diatomite products are made with various aluminum oxide/hydroxide additives via various methods. U.S. Pat. No. 2,036,258 presents a diatomite product coated with aluminum hydroxide by a wet precipitation method, which renders the diatomite surface positively charged in neutral to acidic aqueous media. U.S. Pat. No. 4,980,334 discloses a bio-support made by calcining formed spheres of aluminum hydro-sol and diatomite.

Therefore, a need exists for effective and low cost processes to produce diatomite filter aids with a low soluble arsenic content, especially in the low permeability range of less than about 2 Darcy, wherein such filter aids may be formed from an ore having a high soluble arsenic content.

### SUMMARY

In one aspect, a straight-calcined diatomite filter aid is disclosed which, in addition to diatomite, includes an additive that is either alumina or aluminum hydroxide (ATH). The disclosed filter aid may have a European Brewing Convention (EBC) soluble arsenic content of less than about 10 ppm, or a US Food Chemical Codex (USFCC) soluble arsenic content of less than about 10 ppm, or an International Oenological Codex (OIV) soluble arsenic content of less than about 3 ppm.

In another aspect, a flux-calcined diatomite filter aid is disclosed which, in addition to diatomite, includes an alkali metal flux agent and an additive in the form of either alumina or ATH. The disclosed flux-calcined diatomite filter aid may have an EBC soluble arsenic content of less than about 10 ppm, or a USFCC soluble arsenic content of less than about 10 ppm. In an embodiment, the flux-calcined diatomite filter aid may have an OIV soluble arsenic content of less than about 3 ppm.

In yet another aspect, a method for preparing a straight-calcined diatomite filter aid product is disclosed that includes providing diatomite and at least one of alumina and ATH. The method further includes mixing the alumina or ATH with the diatomite to form a mixture. The method further includes calcining the mixture at a temperature ranging from about 900° C. to about 1200° C. to produce a diatomite filter aid product having an EBC soluble arsenic content of less than about 10 ppm, or a USFCC soluble arsenic content of less than about 10 ppm, or an OIV soluble arsenic content of less than about 3 ppm.

In yet another aspect, a method for preparing a flux-calcined diatomite filter aid is disclosed. The disclosed method includes providing diatomite and at least one of alumina and/or ATH. The method further includes mixing alumina and/or ATH with diatomite to form a mixture. The method further includes calcining the mixture at a temperature ranging from about 900° C. to about 1200° C. to produce a diatomite filter aid product having an EBC soluble arsenic content of less than about 10 ppm, or a USFCC soluble arsenic content of less than about 10 ppm, or an OIV soluble arsenic content of less than about 3 ppm. In a refinement, the method may further comprise providing an alkaline metal flux agent, and the mixing may further include mixing alumina and/or ATH with the flux agent and the diatomite to form a mixture. In the refinement, the diatomite filter aid product produced may have an EBC soluble arsenic content of less than about 10 ppm, or a USFCC soluble arsenic content of less than about 10 ppm.

In yet another aspect, a method for preparing a straight-calcined or flux-calcined diatomite filter aid is disclosed. The disclosed method includes providing at least one of straight-calcined or flux-calcined diatomite and at least one activated alumina. The method further includes mixing the activated alumina with the straight and/or flux-calcined diatomite to form a mixed product having an EBC soluble arsenic content of less than about 10 ppm, or a USFCC soluble arsenic content of less than about 10 ppm, or an OIV soluble arsenic content of less than about 3 ppm.

In any one or more of the embodiments described above, the EBC soluble arsenic content may be less than about 5 ppm.

In any one or more of the embodiments described above, the USFCC soluble arsenic content may be less than about 5 ppm.

In any or more of the embodiments described above, the OIV soluble arsenic may be less than about 1 ppm.

In any one or more of the embodiments described above, the additive may be ATH. In addition, the ATH additive may have a median particle diameter exceeding about 15 microns.

In any one or more of the embodiments described above, the additive may be alumina. In addition, the alumina additive may be an activated alumina. In a further refinement of this concept, the activated alumina may have a specific surface area of exceeding about 100 m2/g.

In any one or more of the flux-calcined embodiments described above, the alkali metal flux agent may be selected from the group consisting of an alkali metal carbonate, a halide and combinations thereof.

In any one or more of the flux-calcined embodiments described above, the alkali metal flux agent may be soda ash.

In any one or more of the embodiments described above, the diatomite filter aid product may have a permeability of less than about 10 Darcy. In some embodiments, the diatomite filter aid product may have a permeability of less than about 1 Darcy.

In any one or more of the embodiments described above, the alumina or ATH may be present in the mixture in an amount of less than about 10 wt %.

### DESCRIPTION

As a solution to the soluble arsenic problem associated with making filter aids from certain diatomite ores, aluminum oxide (Al₂O₃ or “alumina”) and aluminum hydroxide (Al(OH)₃ or “ATH”) are disclosed as effective additives for manufacturing diatomite filter aids with reduced soluble arsenic content, especially in the low permeability range of less than about 2 Darcy. The efficacies of alumina and ATH are established below.

The diatomite feedstock was prepared from several Nevada fresh water diatomite ores by oven drying, hammer milling and air classification. These specific ores are usually not used alone to make diatomite filter aids, especially the slow to medium permeability grades, for their relatively high arsenic content. The chemistry of the diatomite feedstock as measured by X-ray fluorescence (XRF) is shown in Table I.

TABLE I
Major Element Chemistry of Diatomite Feed Examples - XRF (Ignited
Basis)

| | | | | | | | | | As |
|---|---|---|---|---|---|---|---|---|---|
| Diatomite | SiO₂ % | Al₂O₃ % | CaO % | MgO % | Na₂O % | K₂O % | Fe₂O₃ % | TiO₂ % | ppm |
| A | 91.8 | 4.83 | 0.35 | 0.19 | 0.30 | 0.26 | 1.86 | 0.20 | 57 |
| B | 91.7 | 4.88 | 0.35 | 0.19 | 0.28 | 0.25 | 1.93 | 0.22 | 60 |
| C | 91.5 | 3.99 | 0.89 | 0.53 | 0.45 | 0.17 | 2.15 | 0.17 | 33 |
| D | 94.0 | 2.72 | 0.63 | 0.28 | 0.37 | 0.23 | 1.50 | 0.11 | 11 |
| E | 87.4 | 6.88 | 0.95 | 0.64 | 0.30 | 0.21 | 3.05 | 0.39 | 12 |

The various alumina and ATH additives used and their physical properties are listed in Table II. For example, the “ATH-2” aluminum hydroxide has a median particle size (D50) of 18.3 microns. The particle size distribution is measured by a Microtrac S3500 particle size analyzer after dispersion in the sodium silicate solution, except for the coarser samples. The specific surface area is measured by the BET nitrogen adsorption method.

TABLE II
Alumina and Aluminum Hydroxide Additives

| | | | Loss on | | Surface |
|---|---|---|---|---|---|
| | | Moisture | Ignition | D50 | Area |
| Additive | Type | % | % | μm | m²/g |
| ATH-1 | ATH | <1 | 35 | 36 | 0.30 |
| ATH-2 | ATH | <1 | 35 | 18 | 1.0 |
| ATH-3 | ATH | <1 | 34 | 2.0 | 3.3 |
| Alumina-1 | Calcined | <1 | 0.5 | 0.9 | 5.8 |
| | Alumina | | | | |
| Alumina-2 | Activated | <1 | 1 | 115 | 150 |
| | Alumina | | | | |
| Alumina-3 | Activated | 2.4 | 2 | 27 | 209 |
| | Alumina | | | | |
| Alumina-4 | Activated | <1 | 28 | 46 | 344 |
| | Alumina | | | | |

The flux agent, when used, is soda ash, which was hammer-milled and passed through a 325-mesh screen. The soda ash is added to the diatomite feed as a dry powder by brushing the soda ash through a 100-mesh screen. The flux agent, diatomite feed and additive may be mixed in a conventional manner, such as by shaking in a plastic jar.

Batch Calcination

Batch calcination may be conducted in a conventional manner. In the examples shown here, the batch calcination was carried out in a clay crucible in an electrical muffle furnace, although an electrical rotary tube furnace or other suitable furnace may be used. For example, the calcination may be carried out continuously and in an industrial calciner such as a rotary kiln. In the muffle furnace, the feed material was calcined in the clay crucible in air. The batch size was about 40 grams, and the clay crucible has a 7.6 cm (3 in.) diameter and an 11.4 cm (4.5 in.) height. The batches were calcined for about 40 minutes. The calcination products were dispersed by shaking through a 100-mesh screen. The calcinations were carried out at a temperature of about 1037° C. (1900° F.). Other calcination temperatures and methods are available, as will be apparent to those skilled in the art.

Muffle Furnace Calcination

Muffle furnace calcination results are listed in Tables III and IV. Table III shows the results for the straight-calcined samples; Table IV shows the results for the flux-calcined samples using soda ash (4 wt %) as the flux agent.

TABLE III
Muffle Furnace Straight-Calcination with Alumina or ATH at 1037° C.
(1900° F.)

| | | | | Al | | | Soluble | | | EBC soluble, | |
|---|---|---|---|---|---|---|---|---|---|---|---|
| | | | Dosage | added | Perm | WBD | As, ppm | | | ppm | |
| Example | Diatomite | Additive | wt % | wt % | mD | g/ml | OIV | EBC | USFCC | Al | Fe |
| 1 | A | None | 0.0 | 0.0 | 72 | 0.35 | 12 | 17 | 15 | 96 | 40 |
| 2 | A | Alumina-1 | 4.1 | 2.1 | 79 | 0.37 | 9.7 | 15 | 14 | 109 | 39 |
| 3 | A | Alumina-2 | 4.1 | 2.1 | 66 | 0.38 | 3.0 | 5.6 | 5.2 | 229 | 43 |
| 4 | A | Alumina-3 | 4.1 | 2.1 | 84 | 0.35 | 2.0 | 3.7 | 2.2 | 392 | 46 |
| 5 | A | Alumina-4 | 5.4 | 2.1 | 84 | 0.36 | 1.2 | 2.6 | 1.3 | 409 | 38 |
| 6 | B | None | 0.0 | 0.0 | 86 | 0.36 | 14 | 16 | 16 | 96 | 32 |
| 7 | B | Alumina-2 | 4.1 | 2.1 | 93 | 0.36 | 2.7 | 4.7 | 3.3 | 176 | 24 |
| 8 | B | ATH-1 | 6.1 | 2.1 | 79 | 0.38 | 2.3 | 3.8 | 4.6 | 172 | 24 |
| 9 | B | ATH-2 | 6.1 | 2.1 | 90 | 0.36 | 2.6 | 4.1 | 5.5 | 188 | 28 |
| 10 | B | ATH-2 | 3.0 | 1.0 | 77 | 0.37 | 4.6 | 5.6 | 11 | 161 | 37 |
| 11 | B | ATH-3 | 6.1 | 2.1 | 61 | 0.38 | 5.2 | 8.1 | 8.3 | 252 | 48 |
| 12 | C | None | 0.0 | 0.0 | 300 | 0.31 | 18 | 20 | 21 | 90 | 42 |
| 13 | C | ATH-2 | 6.0 | 2.1 | 309 | 0.31 | 5.7 | 7.3 | 8.0 | 185 | 46 |
| 14 | D | None | 0.0 | 0.0 | 90 | 0.30 | 5.5 | 5.3 | n.a. | 90 | 60 |
| 15 | D | ATH-2 | 8.0 | 2.8 | 90 | 0.32 | 0.9 | 0.8 | n.a. | 266 | 60 |
| 16 | E | None | 0.0 | 0.0 | 264 | 0.29 | 5.0 | 5.3 | 4.6 | 106 | 60 |
| 17 | E | ATH-2 | 4.0 | 1.4 | 241 | 0.33 | 1.4 | 1.1 | 1.2 | 156 | 56 |

All of the straight-calcined samples shown in Table III were calcined at about 1037° C. (1900° F.) and show a permeability of 0.06 to 0.31 Darcy. Table III shows that straight-calcined samples made with alumina or ATH as an additive have reduced soluble arsenic content. For example, straight-calcined diatomite A with no alumina or ATH additive has OIV, EBC and USFCC arsenic content of 12, 17 and 15 ppm, respectively (Table III, Example 1), which may be reduced to less than 2, 4, and 3 ppm, respectively, after straight-calcination with an activated alumina as the additive (Table III, Examples 3-4). The calcined alumina of much finer particle size but smaller specific surface area (Table II) was less effective (Table III, Example 2). Straight-calcined diatomite B has OIV, EBC and USFCC arsenic content of 14, 16, and 16 ppm, respectively (Table III, Example 5), which may be reduced to less than 3, 5 and 6 when either an activated alumina or an ATH is used as an additive to the calcination feed (Table III, Examples 6-9). By comparing Examples 8, 9 and 11, it can be seen that the coarser ATH-1 and ATH-2 (median size 36 and 18 μm, respectively, Table II) are more effective than the much finer ATH-3 (median size 2 μm, Table II). Furthermore, straight-calcined diatomite C has OIV, EBC and USFCC arsenic levels of 18, 20 and 21 ppm, respectively (Table III, Example 11), which may be reduced to less than 6, 8 and 8 ppm, respectively, by using ATH-2 as an additive (Table III, Example 12). With the relatively low soluble arsenic diatomites D and E, the addition of ATH-2 further reduced the OIV, EBC, and USFCC arsenic levels from about 5 to about 1 ppm. For all of the diatomite ores (A-E of Table I), about 60% or more reduction of the soluble arsenic content may be achieved.

As shown in Table III, because the additives are aluminum based, higher EBC soluble aluminum content accompanies the reduced soluble arsenic content. See, e.g., Examples 3 and 4. The ATH additives that are most prone to increased EBC aluminum content are those with finer particle sizes and higher surface areas, which at the same time are less effective for soluble arsenic reduction. The coarser ATH more effectively reduces the soluble arsenic content and provides a smaller increase in the soluble aluminum content. Specifically, ATH-2 has a median particle size of 18 μm and a surface area of 1 m²/g (Table II) and produces a filter aid with an EBC soluble aluminum content ranging from 161-188 ppm (Table III, Examples 9-10). In contrast, ATH-3 has a median particle size of 2 μm and a surface area of 3.3 m²/g and produced a filter aid with an EBC soluble aluminum content of 252 ppm (Table III, Example 11). At about 2% added aluminum (˜6% ATH), a low soluble arsenic content product (under 3, 5 and 4 ppm by the OIV, EBC and USFCC methods, respectively) is achievable using a “coarse” (median size >15 μm) and low surface area ATH additive (≦1 m²/g) while maintaining the EBC soluble aluminum content below 200 ppm, and sometimes below the 180 ppm desired level (Table III, Examples 8 and 10), especially with a reduced additive dosage.

TABLE IV
Muffle Furnace Flux-Calcination with 4 wt % Soda Ash as Flux Agent and
ATH as Additive at 1037° C. (1900° F.)

| | | | | Al | | | | | | EBC soluble, | |
|---|---|---|---|---|---|---|---|---|---|---|---|
| | | | Dosage | added | Perm | WBD | Soluble As, ppm | | | ppm | |
| Example | Diatomite | Additive | wt % | wt % | Darcy | g/ml | OIV | EBC | USFCC | Al | Fe |
| 18 | C | None | 0.0 | 0.0 | 1.0 | 0.31 | 11 | 15 | 16 | 69 | 133 |
| 19 | C | ATH-3 | 6.0 | 2.1 | 0.78 | 0.33 | 8.1 | 12 | 12 | 84 | 67 |
| 20 | C | ATH-2 | 6.0 | 2.1 | 0.88 | 0.31 | 5.7 | 6.1 | 8.4 | 188 | 69 |

Flux-calcination data are listed in Table IV. Diatomite C has an OIV, EBC and USFCC arsenic content of 11, 15 and 16 ppm respectively after flux-calcination with 4% soda ash at 1037° C. (1900° F.) (Table, IV, Example 18), which may be reduced to about 6, 6 and 8 ppm, respectively, by using the coarse ATH-2 additive (Table, IV, Example 20). The coarse ATH-2 additive has a median particle size of about 18 μm and a surface area of about 1 m²/g (Table II), and again the finer and higher surface area ATH-3 additive is less effective at reducing the soluble arsenic content than the ATH-2 additive (Table IV, compare Examples 19 and 20). It should be noticed that the flux-calcined diatomite filter aids made with the ATH additives also have a significantly reduced EBC soluble iron content (less than 70 ppm) in comparison to the flux-calcined sample based on diatomite C without an additive (˜130 ppm; Table IV, compare Example 18 with Examples 19-20).

Activated Alumina as Additive to Straight or Flux-calcined Diatomite

Activated alumina may be added to a straight or flux-calcined diatomite product in a conventional manner. In the examples shown below in Table V, 4% by weight of an activated alumina (Alumina-2, Table II) was added to a straight or flux-calcined diatomite product and the two components were mixed. The resulting mixture was subjected to soluble metal analyses, with the results shown in Table V. In each of the examples of Table V, soluble arsenic, either by the OIV, USFCC or EBC method, was reduced by at least 30% and as much as 80%. However, there was a significant increase in alumina solubility in each example of Table V, as determined by the EBC method.

TABLE V
Addition of Activated Alumina to Straight or Flux-Calcined Diatomite

| | | | | | | EBC | |
|---|---|---|---|---|---|---|---|
| | Diatomite | | Alumina-2 | OIV As | USFCC | soluble, ppm | |
| Example | Product* | Type | wt % | ppm | As, ppm | As | Al |
| 21 | FP-1 | Straight- | 0 | 2.9 | 2.7 | 2.9 | 78 |
| 22 | | calcined | 4.0 | 1.7 | 1.8 | 2.0 | 221 |
| 23 | FP-6 | Straight- | 0 | 0.6 | 0.6 | 0.5 | 157 |
| 24 | | calcined | 4.0 | 0.3 | 0.3 | 0.2 | 351 |
| 25 | FW-6 | Flux- | 0 | 4.4 | 4.3 | 4.1 | 186 |
| 26 | | calcined | 4.0 | 3.0 | 2.4 | 2.0 | 320 |
| 27 | FW-14 | Flux- | 0 | 0.8 | 1.2 | 0.7 | 24 |
| 28 | | calcined | 4.0 | 0.4 | 0.8 | 0.4 | 224 |
| 29 | FW-20 | Flux- | 0 | 2.7 | 3.3 | 4.5 | 12 |
| 30 | | calcined | 4.0 | 1.3 | 1.5 | 2.8 | 220 |
| 31 | FW-50 | Flux- | 0 | 1.5 | 1.7 | 1.7 | 23 |
| 32 | | calcined | 4.0 | 0.9 | 0.3 | 0.9 | 211 |

*Products of EP Minerals.

The ATH additives, which may be otherwise called aluminum hydroxide, aluminum trihydroxide, alumina trihydrate (ATH), hydrated alumina, aluminic hydroxide or (ortho)aluminic acid, may include amorphous and any crystalline polymorphs such as gibbsite, bayerite, doyleite, and nordstrandite and the related aluminum oxide-hydroxide boehmite. The ATH additives may be in slurry or powder form and may contain various levels of water or it may be dry. Similarly, the ATH or alumina additives may include amorphous and different crystalline polymorphs such as alpha and gamma alumina. The alumina additives may also be made by different manufacturing processes and have different physical properties, such as activated alumina, calcined alumina, reactive alumina, and submicron alumina. The alumina may be in slurry or powder form and may be hydrated to different degrees or contain various levels of moisture or it may be dry.

The alumina or ATH additive may also be formed in-situ, e.g., by reaction between an aluminum salt, e.g., aluminum chloride (AlCl₃) or aluminum sulfate (Al₂(SO₄)₃.nH₂O or an alum), and a base, e.g., sodium hydroxide (NaOH), potassium hydroxide (KOH) or ammonium hydroxide (NH₄OH). Activated alumina may be produced by calcining ATH.

### INDUSTRIAL APPLICABILITY

Processes to make diatomite filter aids with a reduced soluble arsenic content of less than 3 ppm by the OIV method or less than 10 ppm by the EBC or USFCC method. The processes may be used to reduce arsenic solubility of diatomite filter aids of an already low arsenic solubility. An alumina and/or ATH additive is combined with the diatomite feed, with or without a fluxing agent. Alternatively, an activated alumina is combined with the diatomite after calcination. As compared to either straight-calcined or soda ash (Na₂CO₃)-flux calcined products of similar permeability, products made by the disclosed processes have much lower arsenic solubility. The disclosed processes reduce the soluble arsenic content by about 60% or more in comparison to filter aids of similar permeabilities made from the same ore but without the alumina or ATH additive.

1. A straight-calcined diatomite filter aid comprising:
diatomite;
an aluminum additive selected from the group consisting of alumina and aluminum hydroxide (ATH); and
a soluble arsenic content as analyzed by a method selected from the group consisting of
an International Oenological Codex, by Organisation Internationale de la Vigne et du Vin (OIV), soluble arsenic content of less than about 3 ppm;
a European Brewing Convention (EBC) soluble arsenic content of less than about 10 ppm;
a United States Food Chemical Codex (USFCC) soluble arsenic content of less than about 10 ppm; and
combinations thereof.

2. The straight-calcined diatomite filter aid of claim 1, wherein the OIV soluble arsenic content is less than about 1 ppm.

3. The straight-calcined diatomite filter aid of claim 1, wherein the EBC soluble arsenic content is less than about 5 ppm.

4. The straight-calcined diatomite filter aid of claim 1, wherein the USFCC soluble arsenic content is less than about 5 ppm.

5. The straight-calcined filter aid of claim 1 wherein the aluminum additive is ATH, which has a median particle diameter exceeding about 15 microns.

6. The straight-calcined filter aid of claim 1 wherein the aluminum additive is alumina, wherein further the alumina is activated alumina.

7. A flux-calcined diatomite filter aid comprising:
diatomite;
an alkali metal flux agent;
an aluminum additive selected from the group consisting of alumina and aluminum hydroxide (ATH); and
a soluble arsenic content as analyzed by a method selected from the group consisting of
an International Oenological Codex, by Organisation Internationale de la Vigne et du Vin (OIV), soluble arsenic content of less than about 3 ppm;
a European Brewing Convention (EBC) soluble arsenic content of less than about 10 ppm;
a United States Food Chemical Codex (USFCC) soluble arsenic content of less than about 10 ppm; and
combinations thereof.

8. The flux-calcined diatomite filter aid of claim 7 wherein the OIV soluble arsenic is less than about 1 ppm.

9. The flux-calcined diatomite filter aid of claim 7 wherein the EBC soluble arsenic is less than about 5 ppm.

10. The flux-calcined diatomite filter aid of claim 7 wherein the aluminum additive is ATH, which has a median particle diameter exceeding about 15 microns.

11. The flux-calcined diatomite filter aid of claim 7 wherein the aluminum additive is alumina, wherein further the alumina is activated alumina.

12. The flux-calcined diatomite filter aid of claim 7 wherein the alkali metal fluxing agent is selected from the group consisting of an alkali metal carbonate, a halide and combinations thereof.

13. The flux-calcined diatomite filter aid of claim 7 wherein the alkali metal fluxing agent is soda ash.

14. A method for preparing a straight-calcined diatomite filter aid product comprising:
providing at least one of alumina and aluminum hydroxide (ATH) and diatomite;
mixing the at least one of alumina and ATH with the diatomite to form a mixture; and
calcining the mixture at a temperature ranging from about 900° C. to about 1200° C. to produce the diatomite filter aid product having a soluble arsenic content as analyzed by a method selected from the group consisting of
an International Oenological Codex, by Organisation Internationale de la Vigne et du Vin (OIV), soluble arsenic content of less than about 3 ppm;
a European Brewing Convention (EBC) soluble arsenic content of less than about 10 ppm;
a United States Food Chemical Codex (USFCC) soluble arsenic content of less than about 10 ppm; and
combinations thereof.

15. The method of claim 14 wherein the OIV soluble arsenic content of the calcined diatomite filter aid product is less than about 1 ppm.

16. The method of claim 14 wherein the EBC soluble arsenic content of the calcined diatomite filter aid product is less than about 5 ppm.

17. The method of claim 14 wherein the USFCC soluble arsenic content of the calcined diatomite filter aid product is less than about 5 ppm.

18. The method of claim 14 wherein the diatomite filter aid product has a permeability of less than about 1 Darcy.

19. The method of claim 14 wherein the alumina or ATH is present in the mixture in an amount of less than about 10 wt %.

20. A method for preparing a flux-calcined diatomite filter aid product comprising:
providing at least one of alumina and aluminum hydroxide (ATH);
providing an alkali metal flux agent and a diatomite;
mixing at least one of alumina and ATH with the flux agent and the diatomite to form a mixture; and
calcining the mixture at a temperature ranging from about 900° C. to about 1200° C. to produce the diatomite filter aid product having a soluble arsenic content as analyzed by a method selected from the group consisting of
an International Oenological Codex, by Organisation Internationale de la Vigne et du Vin (OIV), soluble arsenic content of less than about 3 ppm;
a European Brewing Convention (EBC) soluble arsenic content of less than about 10 ppm;
a United States Food Chemical Codex (USFCC) soluble arsenic content of less than about 10 ppm; and
combinations thereof.

21. The method of claim 20 wherein the OIV soluble arsenic content of the flux-calcined diatomite filter aid product is less than about 1 ppm.

22. The method of claim 20 wherein the EBC soluble arsenic content of the flux-calcined diatomite filter aid product is less than about 5 ppm.

23. The method of claim 20 wherein the diatomite filter aid product has a permeability of less than about 10 Darcy.

24. The method of claim 20 wherein the alumina or ATH is present in the mixture in an amount of less than about 10 wt %.

25. A method for preparing a calcined diatomite filter aid product comprising:
providing activated alumina;
providing a calcined diatomite;
mixing the activated alumina and the calcined diatomite to form a mixture that is a diatomite filter aid product with a soluble arsenic content as analyzed by a method selected from the group consisting of
an International Oenological Codex, by Organisation Internationale de la Vigne et du Vin (OIV), soluble arsenic content of less than about 3 ppm;
a European Brewing Convention (EBC) soluble arsenic content of less than about 10 ppm;
a United States Food Chemical Codex (USFCC) soluble arsenic content of less than about 10 ppm; and
combinations thereof.

26. The method of claim 25 wherein the calcined diatomite is a straight calcined diatomite.

27. The method of claim 25 wherein the calcined diatomite is a flux-calcined diatomite.

28. The method of claim 25 wherein the activated alumina is present in the mixture in an amount of less than about 10 wt %.
